(19) United States
(12) Patent Application Publication
(10) Pub. No.: US 2006/0259244 A1
(43) Pub. Date: Nov. 16, 2006

(54) Level 3 fusion engine for detection and tracking of chemical biological, nuclear and radiological hazards

(75) Inventor: Timothy J. Case, Eldersburg, MD (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 11/099,027

(22) Filed: Apr. 5, 2005

Related U.S. Application Data
(60) Provisional application No. 60/657,168, filed on Feb. 28, 2005.

(51) Int. Cl. G06F 19/00

(52) U.S. Cl. 702/19; 702/22

(57) ABSTRACT

A chemical, biological, radiological and nuclear (CBRN) hazard detecting system. In one embodiment, the CBRN hazard detecting system includes a plurality of sensors, a plurality of acoustic sensors, one or more weather sensors and a level 3 fusion engine. The level 3 fusion engine is in communication with the plurality of CBRN sensors, the plurality of acoustic sensors and the one or more weather sensors. Moreover, the level 3 fusion engine is adapted to detect and track CBRN hazards based in part on data received from the CBRN sensors, the acoustic sensors, the one or more weather sensors and predictive hazard models.

### TECHNICAL FIELD

The present invention relates generally to detection devices and in particular to the detection and tracking of chemical, biological, nuclear and radiological hazards. BACKGROUND

The ability to use multiple chemical, biological, radiological and nuclear (CBRN) sensors to detect and track hazards in a combat situation is neither a trivial nor a straightforward problem to solve. First of all, CBRN sensors are known to have high false alarm rates. This is due to the fact that the range of concentration levels that the sensors must detect is large and often dynamic. Moreover, CBRN hazards are spatially expansive and dynamic. Typically sensor fusion methodologies for detecting and tracking targets are based on the assumption that a target is static in terms of its extent and structure and will not function properly with dynamic, volumetric targets. In addition, most CBRN detectors are point sensors. That is, most CBRN sensors collect information from a single spatial location. This makes any type of data fusion difficult since there is no over-sampling of the target in the spatial domain. Finally, the concepts of operation (CONOPS) for CBRN detection use a limited number of point and standoff sensors which may be mobile. As a result, there are limited readings in both the temporal and spatial domains and there will be few instances where there are many data points reported from any single special location. Current systems being developed initially attempt to detect and track CBRN hazards only using a level 1 (L1) fusion engine. A L1 fusion engine uses only CBRN sensor data in a L1 fusion algorithm which limits the amount of temporal and spatial resolution provided to the algorithm. Accordingly, the performance of the L1 fusion algorithm is limited. For the reasons stated above, this method will not be effective in properly identifying and tracking spatially expansive CBRN hazards.

For the reasons stated above and for other reasons stated below which will become apparent to those skilled in the art upon reading and understanding the present specification, there is a need in the art for an improved device for detecting CBRN hazards.

### SUMMARY OF INVENTION

The above-mentioned problems with traditional hazard detectors are addressed by embodiments of the present invention and will be understood by reading and studying the following specification.

In one embodiment, a hazard detecting system is provided. The hazard detecting system includes a plurality of chemical, biological, radiological and nuclear (CBRN) sensors, a plurality of acoustic sensors, one or more weather sensors; and a level 3 fusion engine. The level 3 fusion engine is in communication with the plurality of CBRN sensors, the plurality of acoustic sensors and the one or more weather sensors. Moreover, the level 3 fusion engine is adapted to detect and track CBRN hazards based in part on data received from the CBRN sensors, the acoustic sensors, the one or more weather sensors and predictive hazard models.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is a block diagram of a CBRN hazard detecting system of one embodiment of the present invention; and

FIG. 2 is a flow diagram of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide a level 3(L3) fusion engine that detects and tracks CBRN hazards. In one embodiment, a L3 fusion engine utilizes various types of sensors and a predictive model scheme that provides a way to fill in gaps in both time and space. Further in one embodiment, a fusion engine utilizes data from CBRN, acoustic and weather sensors, in conjunction with a predictive hazard models to enhance the data for a more accurate detection of CBRN hazards.

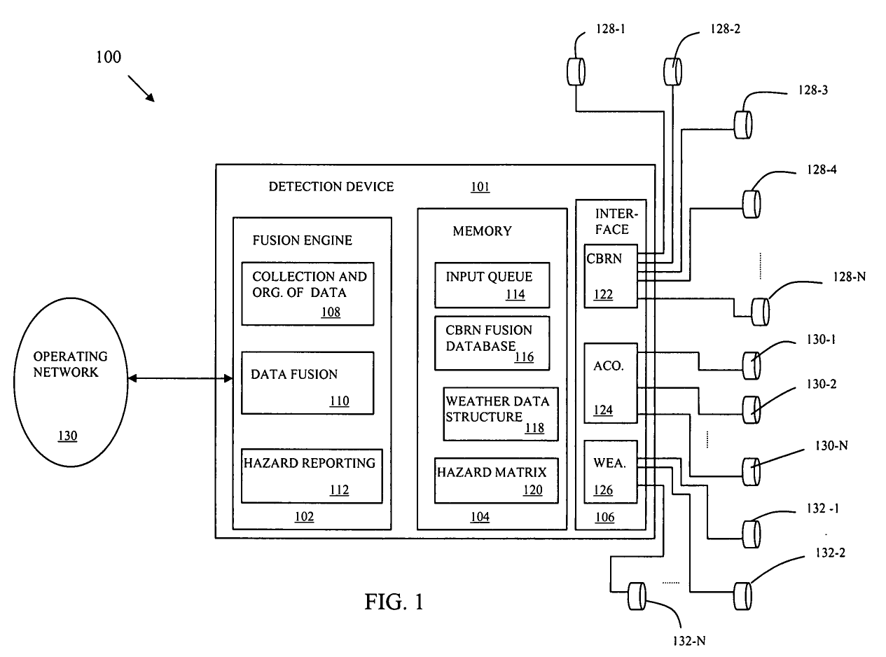

Referring to FIG. 1, a CBRN detecting system 100 of one embodiment of the present invention is illustrated. As illustrated, the CBRN detecting system includes operating network, detection device 101, sensors 128-1 though 128-N, sensors 130-1 through 130-N and sensors 132-1 through 132-N. The detection device 101 is in communication with the operating network 130. In one embodiment the operating network is a system of systems common operating environment (SOSCOE). In embodiments of the present invention, sensor data is propagated across the network in a standard format the fusion engine 102 can utilize. In one embodiment, the flow of data from the network is asynchronous. Moreover, in embodiments of the present invention, results from the L3 fusion engine 102 are reported back to the common operating network 130 for use by higher level situation awareness processes.

As illustrated in FIG. 1, the detection device 101 includes the fusion engine 102, memory 104 and interface circuit 106. The fusion engine 102 in this embodiment has three modules, a collection and organization of data 108, a data fusion 110 and a hazard reporting 112 module. The memory 104 includes an input queue 114, a CBRN fusion database 116, weather data structure 1 18 and hazard matrix 120. The sensor interface 106 is adapted to provide an interface between the sensors 128-1 through 128-N, 130-1 through 130-N and 132-1 through 132-N and the detection device 101. The sensor interface 106 includes a CBRN interface circuit 122, an acoustic interface circuit 116 and a weather interface circuit 126. The CBRN interface circuit 122 is coupled to a plurality of CBRN sensors 128-1 through 128-N. The acoustic interface circuit 124 is coupled to acoustic sensors 130-1 through 130-N and the weather interface circuit 126 is coupled to a weather sensors 132-1 through 130-N. The sensor interface must be able to process incoming data either directly from the local sensor circuit or from remote sensing units via sensor reports that are received across the operating network 130.

The data structures, input queue 114, CBRN fusion database 116, weather data structure 118 and hazard matrix 120 are maintained by the fusion engine 102. The input queue 114 is adapted to hold incoming sensor reports until the fusion engine is ready to process a temporal block of data. The CBRN fusion database l16is a three dimensional (3-D) structure that is adapted to hold sensor data in a temporal and spatial location for data fusion. The amount of temporal and spatial resolution in the database 1 16 is variable and is user defined. The weather data structure 118 is adapted to contain weather information collected from the area under analysis by the weather sensors 132-1 through 132-N. The hazard matrix 120 is used to report results to other situational awareness software. In particular, the hazard matrix array 120 is a N dimensional (N-D) array of hazard related data which represents the volume of the hazard as well as the hazard type and level of concentration. The hazard matrix array 120 is packaged and transmitted across the network 130 to accomplish this task whenever a hazard is present.

The collection of and organization of data module 104 in the fusion engine 102 places in a message queue 114 events that arrive from the operating network 130. At regular fixed intervals, events stored in the queue 114 are processed. After all events in the queue are processed, they are removed from the queue and the system waits for the time interval to expire before polling the queue 114 again. Two types of sensor data processed by the fusion engine are CBRN data from sensors 128-1 through 128-N and acoustic data from acoustic sensors 130-1 through 130-N. Acoustic data is tested to see if the signature matches that of a CBRN source detonation. If there is no match, the acoustic event is ignored. Acoustic signatures matching the parameters of a CBRN source detonation are added to the fusion engine's database 116. All acoustic events added to the database 116 are analyzed in both the spatial and temporal domains. Embodiments of the present invention uses at least three acoustic sensors 130-1 through 130-N to triangulate where a CBRN event occurs. Based on the location and time, events are either grouped with existing events in the database 116 or are identified as potential new CBRN sources. After grouping of the acoustical data, the CBRN source location is determined for all potential CBRN sources and database 116 is updated. All CBRN events are added to the database 116. A new CBRN event is grouped with other CBRN events based on time and spatial location.

The data fusion module 110 in the fusion engine 102 is used to generate regions where a CBRN hazard may exist based on potential CBRN source locations, weather data from the weather sensors 132-1 through 132-N and hazard area prediction models. The CBRN data from the database 116 are used to validate all potential CBRN hazard regions. Regions where CBRN data match the predicted CBRN hazard model are saved and assigned a level of confidence based on how well the model and the data match. CBRN events that don't match any of the generated hazard regions are flagged as suspicious but are kept in the database 116 for a user-defined length of time before they are either supported by other colleted data or dropped as a false alarm.

The hazard reporting module 112 generates a hazard matrix (HM) for CBRN hazard events reported in a given time period. The HM contains a source position, a hazard area, the type of hazard, a concentration map and a confidence level for each hazard present. The HM is broadcast over the operating network 130 for situation awareness (SA) algorithms to utilize. The fusion engine database 116 is updated after a HM is created. Data older than the temporal span of the database is dropped as well as CBRN points that have been deemed as false alarms. Any sensor reporting false alarms are added to a structure so that tracking may be done. A sensor consistently giving false alarms will be flagged by the fusion engine 102 as unreliable and a service request will be sent to the operating network 130.

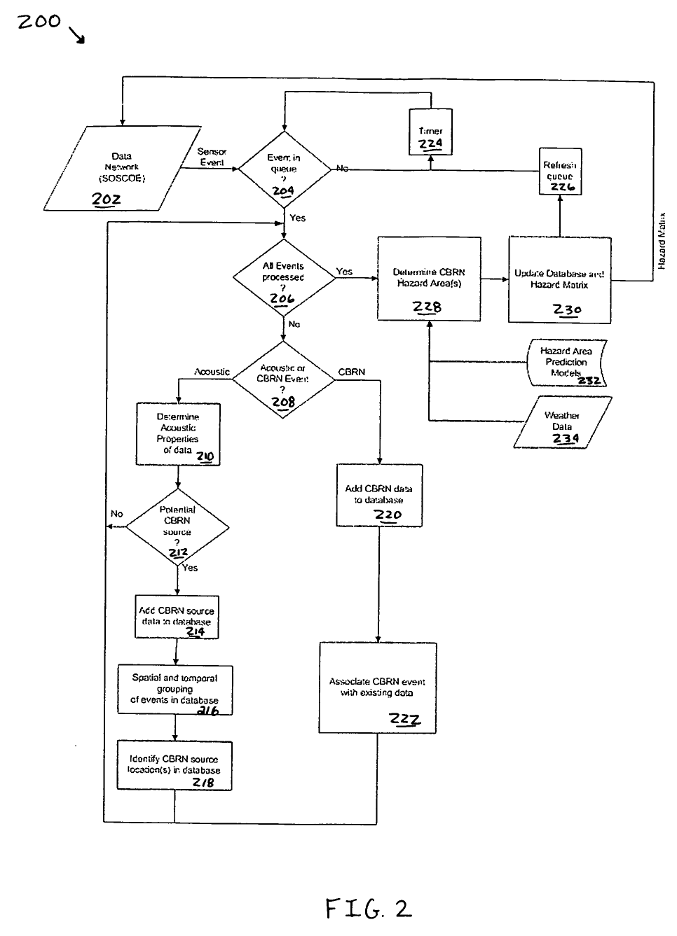

FIG. 2 illustrates a flow chart 200 illustrating a method of performing a detection and tracking of CBRN hazards of one embodiment of the present invention. As illustrated, when an event arrives from the operating network (202), it is placed in the queue (204). A time interval is observed before the queue is polled again (224). This time variable is user controlled and may be changed via a command sequence sent over the operating network (202). When an event is observed in the queue (204), it is determined if all the events have been processed (206). If all the events have not been processed (206), it is further determined if the event is an acoustic or a CBRN event (208). If it is an acoustic event (208), the acoustic properties of the data are determined (210). Then it is determined if the acoustic event is from a potential CBRN source (212). If it is not from a potential CBRN source (214), it is once again determined if all the events have been processed (206). If it is determined that the acoustic event is from a potential CBRN source, (212), the acoustic data are added to the database (214). Spatial and temporal placement of the acoustic event is used to either group the current event with an existing event in the database or identify the event as a new CBRN source (216). The identity of the CBRN source and locations are then placed in the data base (218). Once again, it is then determined if all events have been processed (206).

If it is determined that a CBRN event has occurred (208), the CBRN data are added to the database (220). The CBRN event is grouped with other CBRN events based on time and spatial location (222). It is then determined if all events have been processed (206). If all the events have been processed (206), the CBRN hazard area(s) are determined (228). This is accomplished with hazard area prediction models (232) that utilize the acoustic and weather data (234). The CBRN data are then used to validate and refine the hazard regions once the CBRN hazard area(s) have been determined (228). The database and hazard matrix are updated and the hazard matrix is passed to the operating network (230).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A fusion engine for detection and tracking of chemical, biological, radiological and nuclear (CBRN) hazards, the fusion engine comprising:
a collection and organization of data module adapted to store event data in an input queue;
a data diffusion module adapted to process CBRN data, acoustic data and prediction models to determine CBRN hazard events; and
a hazard reporting module adapted to generate a hazard matrix for CBRN hazard events determined in a given time period.

2. The fusion engine of claim 1, wherein the data diffusion module is further adapted to test acoustic data to determine if its signature matches parameters of a CBRN source detonation.

3. The fusion engine of claim 2, wherein the data diffusion module is further adapted to add acoustic events that have a signature match to a database.

4. The fusion engine of claim 3, wherein the data diffusion module is further adapted to analyze acoustic events added to the database in both the spatial and temporal domains.

5. The fusion engine of claim of 1, wherein the data diffusion module is further adapted to determine the source location of a CBRN hazard event.

6. The fusion engine of claim 5, wherein the data fusion engine is further adapted to add CBRN hazard events to a database.

7. A hazard detecting system comprising:
a plurality of chemical, biological, radiological and nuclear (CBRN) sensors, each CBRN sensor adapted to detect a CBRN event;
a plurality of acoustic sensors, each acoustic sensor adapted to detect an acoustic event;
one or more weather sensors, each weather sensor adapted to detect weather conditions; and
a detection device, the detection device including;
an interface circuit adapted to interface data signals received from the CBRN, acoustic and weather sensors,
a memory adapted to store CBRN related data, and
a fusion engine adapted to process CBRN events, acoustic events weather conditions along with predictive models to determine hazard events.

8. The hazard detecting system of claim 7, wherein the fusion engine is further in communication with an operating network.

9. The hazard detecting system of claim 7, wherein the memory further comprises at least one of an input queue adapted to store events, a CBRN fusion database adapted to store sensor data in a temporal and special location, a weather data structure adapted to store weather information collected by the one or more weather sensors and a hazard matrix adapted to store a N dimensional array of hazard related data which represents the volume of the hazard as well as the hazard type and level concentration.

10. The hazard detecting system of claim 7, wherein the fusion engine further comprises at least one of a collection and organization of data module adapted to place event data in an input queue, a data fusion module adapted to process CBRN and acoustic events and a hazard reporting module adapted to generate a hazard matrix.

11. The hazard detecting system of claim 7, further comprising:
a operating network in communication with the detection device.

12. The hazard detecting device of claim 11, wherein the operating network is adapted to provide remote senor data to the fusion engine via the interface circuit.

13. The hazard detecting device of claim 1 1, wherein data flowing from the operating network is asynchronous.

14. The hazard detecting device of claim 11, wherein the fusion engine is adapted to report events to the operating network for higher level situation awareness processes.

15. A hazard detecting system comprising:
a plurality of chemical, biological, radiological and nuclear (CBRN) sensors;
a plurality of acoustic sensors;
one or more weather sensors; and
a level 3 fusion engine in communication with the plurality of CBRN sensors, the plurality of acoustic sensors and the one or more weather sensors, the level 3 fusion engine adapted to detect and track CBRN hazards based in part on data received from the CBRN sensors, the acoustic sensors, the one or more weather sensors and predictive hazard models.

16. The hazard detecting device of claim 15, further comprising:
an operating network in communication with the level 3 fusion engine, the operating network adapted to process results from the level 3 fusion engine with higher level situation aware processes.

17. The hazard detecting device of claim 16, wherein the operating network is further adapted to provide additional sensor data to the level 3 fusion engine via an interface circuit.

18. A method of detecting chemical, biological, radiological and nuclear (CBRN) hazards, the method comprising:
detecting an CBRN event;
associating the CBRN event with existing data;
determining a CBRN hazard area based at least in part on the detected CBRN event, weather data and hazard prediction models; and
creating a hazard matrix based on the determined CBRN hazard area.

19. The method of claim 18, further comprising:
adding the CBRN event to a database;

20. The method of claim 18, further comprising:
after creating the hazard matrix, updating the database of existing data.

21. The method of claim 18, further comprising:
determining if an acoustical event has occurred.

22. The method of claim 21, further comprising:
when an acoustic event has occurred, determining the acoustical properties of data; and
determining if the acoustic event is associated with a potential CBRN source.

23. The method of claim 22, further comprising:
when the acoustic event is associated with a CBRN source, add a CBRN source to a database;
grouping events in the database spatially and temporally; and
identifying CBRN source locations in the database.

24. The method of claim 18, further comprising:
placing a sensor event in a queue; and
processing the sensor event.

25. The method of claim 24, further comprising:
determining if a sensor event is in the queue; and
when an event is not observed in the queue, observing a time interval before the queue is polled again.

26. A method of detecting and tracking chemical, biological, radiological and nuclear (CBRN) hazards, the method comprising:
detecting CBRN events with at least one of a plurality of CBRN sensors;
detecting acoustic events with a plurality of acoustic sensors;
detecting weather conditions with at least one weather sensor; and
processing CBRN events, acoustic events, weather conditions and prediction models to determine hazard regions.

27. The method of claim 26, further comprising:
assigning a level of confidence to hazard regions based in part on how well at least one of the CBRN events, acoustic events and weather data match the prediction models.

28. The method of claim 26, further comprising:
flagging as suspicious CBRN events that don't match the prediction models; and
storing the flagged CBRN event in a database until at least one of other like CBRN events are observed and a user defined length of time has passed.

29. The method of claim 26, further comprising;
generating a hazard matrix in a given time period;
broadcasting the hazard matrix to a operating network; and
applying situational awareness algorithms to the hazard matrix.

30. The method of claim 26, further comprising;
tracking false reporting from the CBRN sensors, acoustic sensors and the weather sensors; and
sending a service request to a operating network when a sensor consistently provides false reporting.

31. The method of claim 26, further comprising:
adding acoustic events to a database; and
analyzing the acoustic events in both special and temporal domains.

32. The method of claim 26, further comprising:
sending at least one of CBRN events, acoustic events and weather events via operating network.

33. The method of claim 26, further comprising:
formatting the at least one of the sent CBRN events, acoustic events and weather events to be the same as associated detected CBRN events, acoustic events and weather events.

34. A hazard detecting device comprising:
a means for sensing chemical, biological, radiological and nuclear (CBRN) events;
a means for sensing acoustical events;
a means for sensing weather;
a means for applying predictive hazard models to the sensed events and the sensed weather to provide a hazard warning.

35. The hazard detecting device of claim 34, further comprising:
a means of determining acoustical event locations.

36. The hazard detecting device of claim 34, further comprising:
a means for providing adjustable timed widows for hazard events.
